(19) United States
(12) Patent Application Publication
(10) Pub. No.: US 2026/0072759 A1
(43) Pub. Date: Mar. 12, 2026

(54) SYSTEM AND METHOD FOR DYNAMIC SWITCHING OF GRAPHICS PROCESSING UNIT WORKLOADS

(71) Applicant: Aarna Networks Inc., San Jose, CA (US)

(72) Inventors: Sriram RUPANAGUNTA, Bangalore (IN); Amar KAPADIA, San Jose, CA (US); Sandeep SHARMA, Bangalore (IN); Bhanu Chandra K, Bangalore (IN); Raghuram GOPALSHETTY, Bangaluru (IN); Milind JALWADI, Pune (IN)

(73) Assignee: Aarna Networks Inc., San Jose, CA (US)

(21) Appl. No.: 19/228,937

(22) Filed: Jun. 5, 2025

(30) Foreign Application Priority Data
Sep. 6, 2024 (IN) 202441067672

(51) Int. Cl. G06F 9/50; G06T 1/20

(52) U.S. Cl. CPC G06F 9/5083; G06T 1/20; G06F 2209/5019

(57) ABSTRACT

A system (108) and method (400) for dynamically managing graphics processing unit (GPU) workloads in GPU artificial intelligence (AI) cloud infrastructure (210) are disclosed. The method (400) involves monitoring, by an orchestrator (202), the GPU AI cloud infrastructure (210) comprising one or more types of workloads (208), wherein the one or more types of workloads (208) indicate different use cases that require computational tasks executed on the infrastructure. The orchestrator (202) receives one or more policy specifications from one or more users (102), wherein the policy specifications include a set of user-defined rules and configurations to manage the execution of the workloads (208) on one or more GPU resources. Based on the received policy specifications, the orchestrator (202) switches between the one or more types of workloads (208) and modifies the GPU AI cloud infrastructure (210) accordingly.

### FIELD OF THE INVENTION

The present invention relates generally to a field of Graphics Processing Unit (GPU) orchestration and resource management, and more particularly, to a system and a method for dynamic switching of GPU workloads.

### BACKGROUND

Graphics Processing Units (GPUs) have been developed as specialized hardware accelerators to perform highly parallel computations across extensive datasets. While originally utilized for rendering graphical content, GPUs have been adopted extensively within artificial intelligence (AI) cloud infrastructures to accelerate computationally intensive tasks such as model training and inference in machine learning (ML) workflows. Computational operations executed by large-scale language models and other deep learning architectures require significant GPU throughput due to their reliance on tensor operations and large matrix computations.

The GPU AI cloud infrastructures are increasingly supporting a wide range of workload types that extend beyond traditional model training. Examples include high-performance computing (HPC) for complex scientific simulations, generative AI for content creation, and telecommunications workloads such as radio access network (RAN) processing. Each type of workload exhibits distinct computational behavior, including variations in latency sensitivity, throughput demand, memory utilization, and execution duration. As a result, managing heterogeneous workloads within a shared GPU infrastructure has introduced substantial operational complexity.

In current practice, GPU workload management is frequently based on static provisioning strategies, wherein fixed GPU resources are allocated to predefined workloads. The static approaches have led to significant inefficiencies in resource utilization due to variability in workload intensity, unpredictable runtime conditions, and changing user priorities. Furthermore, the lack of real-time policy enforcement mechanisms limits the responsiveness of GPU infrastructure to dynamic workload demands. As GPU infrastructures scale and workload diversity increases, the challenge of aligning GPU resource availability with real-time computational requirements remains unresolved

Therefore, in view of the above-mentioned problems, it is desirable to provide a system and a method that may eliminate the above-mentioned problems of the existing solutions.

### SUMMARY

This summary is provided to introduce a selection of concepts, in a simplified format, that are further described in the detailed description of the present disclosure. This summary is neither intended to identify key or essential inventive concepts of the present disclosure nor is it intended for determining the scope of the present disclosure.

The present disclosure discloses a method for dynamically managing graphics processing unit (GPU) workloads in artificial intelligence (AI) cloud infrastructure. The method includes monitoring, by an orchestrator, the GPU AI cloud infrastructure comprising one or more types of workloads. The one or more types of workloads indicate different use cases that require computational tasks that are executed on the AI cloud infrastructure. The method further includes receiving, by the orchestrator, one or more policy specifications from a user. The one or more policy specifications indicate a set of user-defined rules and configurations to manage the one or more types of workloads to run on the one or more GPU resources. The method further includes switching, by the orchestrator, the one or more types of workloads based on the received one or more policy specifications. The method further includes modifying, by the orchestrator, the GPU AI cloud infrastructure based on the switching of the one or more types of workloads thereby dynamically managing the GPU workloads in the cloud infrastructure.

In another embodiment, a system for dynamically managing graphics processing unit (GPU) workloads in artificial intelligence (AI) cloud infrastructure is disclosed. The system includes a memory. The system further includes at least one processor coupled with the memory. The system includes at least one processor that is configured to monitor the GPU AI cloud infrastructure comprising one or more types of workloads. The one or more types of workloads indicates different use cases that require computational tasks that are executed on the AI cloud infrastructure. The processor is further configured to receive one or more policy specifications from a user. The one or more policy specifications indicate a set of user-defined rules and configurations to manage the one or more types of workloads to run on one or more GPU resources. The processor is further configured to switch the one or more types of workloads based on the received one or more policy specifications. The processor is further configured to modify the GPU AI cloud infrastructure based on the switching of the one or more types of workloads, thereby dynamically managing the GPU workloads in the AI cloud infrastructure.

To further clarify the advantages and features of the present disclosure, a more particular description of the present disclosure will be rendered by reference to specific embodiments thereof, which are illustrated in the appended drawings. It is appreciated that these drawings depict only typical embodiments of the present disclosure and are therefore not to be considered limiting of its scope. The present disclosure is described and explained with additional specificity and detail with the accompanying drawings.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates an environment for an implementation of a system for dynamically managing graphics processing unit (GPU) workloads in artificial intelligence (AI) cloud infrastructure, according to an embodiment of the present disclosure;

FIG. 2 illustrates a schematic diagram depicting an architecture of the system for dynamically managing the graphics processing unit (GPU) workloads in the artificial intelligence (AI) cloud infrastructure, according to an embodiment of the present disclosure;

FIG. 3 illustrates a schematic diagram depicting the system for dynamically managing the graphics processing unit (GPU) workloads in the artificial intelligence (AI) cloud infrastructure, according to an embodiment of the present disclosure; and

FIG. 4 illustrates a flowchart depicting a method for dynamically managing the graphics processing unit (GPU) workloads in the artificial intelligence (AI) cloud infrastructure, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the present disclosure, reference will now be made to the various embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the present disclosure will be described below in detail with reference to the accompanying drawings.

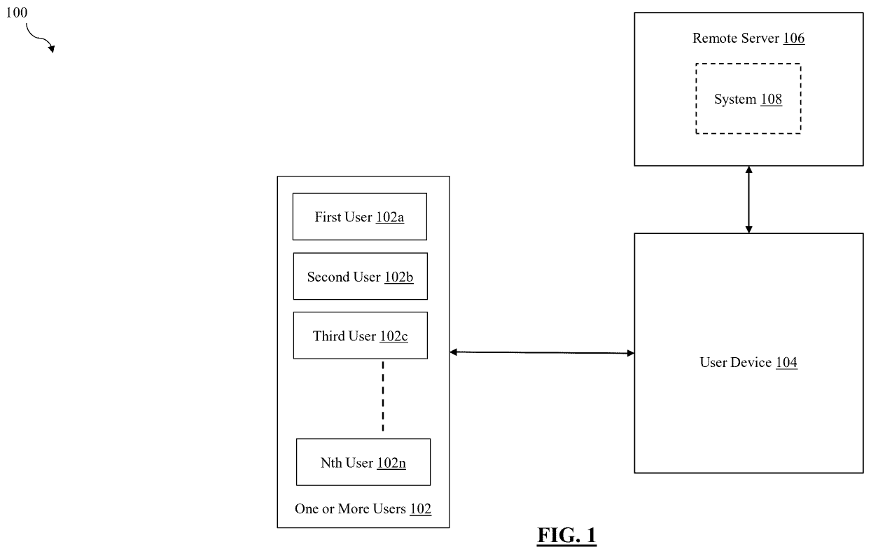

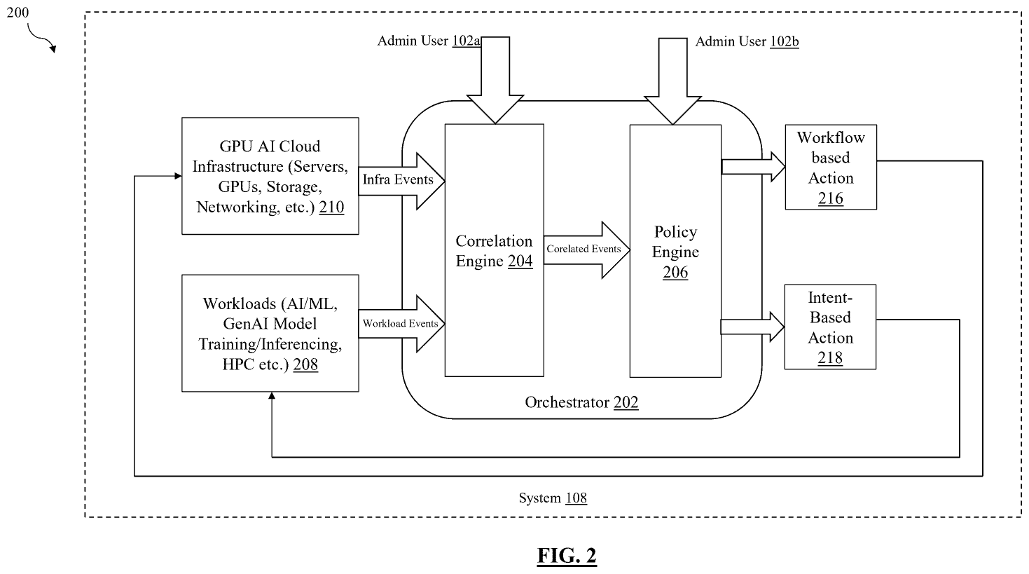

For the sake of clarity, the first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2.

FIG. 1 illustrates an environment 100 for an implementation of the system 108 for dynamically managing graphics processing unit (GPU) workloads in artificial intelligence (AI) cloud infrastructure, according to an embodiment of the present disclosure.

The environment 100 may include one or more users 102, a user device 104 associated with the one or more users 102, and a remote server 106 in communication with the user device 104. The one or more users 102 may be represented as a first user 102a, a second user 102b, a third user 102c, and up to N^{th} user 102n.

In an embodiment, the one or more users 102 may interact with the user device 104 by providing suitable commands through a user interface (UI) of the user device 104. In an embodiment, the environment 100 may include the system 108 that may be implemented at the remote server 106.

In a non-limiting example, the user device 104 may include a computer, a desktop, a laptop, a tablet, a fablet, or a smartphone. The user device 104 may be configured to communicate with the remote server 108 through a wired or wireless communication channel such as Wireless Fidility (Wi-Fi), Bluetooth, Fourth Generation/Fifth Generation (4G/5G), or radio frequency (RF)communication.

In an exemplary embodiment, the one or more users 102 operating the user device 104 may control the system 108 by providing one or more instructions in the form of code or a command. In an exemplary scenario, the user 102a may give one or more inputs to the system 108. The one or more inputs may include correlation rules and policy rules. The command or code may indicate parameters such as the number of GPUs, memory requirements, a preferred cloud region, and a priority level. The system 108, upon receiving such instructions, may be configured to dynamically manage the GPU workloads in the GPU AI cloud infrastructure 210.

In another exemplary embodiment, the one or more users 102 may install a predefined application dedicated for managing GPU workloads in the AI cloud infrastructure on the user device 104. The predefined application may provide the UI interface on the user device 104 for controlling the system 108.

In an embodiment, the system 108 may be configured to monitor the GPU AI cloud infrastructure 210 comprising one or more types of workloads. The one or more types of workloads 208 may indicate different use cases that require computational tasks such as matrix multiplications for deep learning model training, convolution operations for image recognition, tensor transformations for natural language processing that are executed on the AI cloud infrastructure.

For example, the different use cases may include real-time video inference for surveillance systems, large-scale model training for natural language processing (NLP), high-resolution image generation using generative adversarial networks (GANs), scientific simulations such as molecular dynamics, and batch-based data analytics for enterprise intelligence. Each use case demands varying levels of GPU compute, memory, and latency requirements, which are dynamically managed by the system 108 based on user-defined policy specifications and infrastructure state.

The system 108 may be further configured to receive one or more policy specifications from the one or more users 102. The one or more policy specifications indicate a set of user-defined rules and configurations to manage the one or more types of workloads 208 to run on the one or more GPU resources. In one embodiment, the one or more policy specifications may include one or more pre-defined parameters related to the one or more types of the workloads.

The system 108 may be further configured to switch the one or more types of workloads 208 based on the received one or more policy specifications.

The system 108 may be configured to modify the GPU AI cloud infrastructure based on the switching of the one or more types of workloads 208, thereby dynamically managing the GPU workloads in the GPU AI cloud infrastructure 210.

In another embodiment, the system 108 may be configured to track performance metrics of the one or more types of workloads 208 in real-time.

In another embodiment, the system 108 may be configured to reallocate one or more GPU resources between the one or more types of workloads 208 based on the policy specified by the one or more users 102.

In various embodiments, the system 108 for dynamically managing graphics processing unit (GPU) workloads in artificial intelligence (AI) cloud infrastructure will be discussed in detail in conjunction with FIG. 2.

FIG. 2 illustrates the schematic diagram depicting an architecture 200 of the system 108 for dynamically managing the GPU workloads in the GPU AI cloud infrastructure 210, according to an embodiment of the present disclosure.

In an embodiment of the present disclosure, the architecture 200 may be implemented to dynamically manage the GPU workloads in the AI cloud infrastructure 210. The architecture 200 may include an orchestrator 202, the AI cloud infrastructure 210, and one or more types of workloads 208. The orchestrator 202 may further include a correlation engine 204 and a policy engine 206. In an embodiment, the orchestrator 202, the AI cloud infrastructure 210, and the one or more types of workloads 208 may be in communication with each other.

In an embodiment, the orchestrator 202 may be configured to facilitate dynamic management of GPU workloads in the GPU AI cloud infrastructure 210 based on the user-defined policy specifications. Further the orchestrator 202 may be configured to monitor the GPU AI cloud infrastructure 210, including the one or more types of workloads 208 that represent distinct use cases executed on the one or more GPU resources. The orchestrator 202 may be further configured to track the performance metrics in real-time, such as GPU utilization, the memory consumption, the task latency, the throughput, or the energy usage.

The orchestrator 202 may dynamically switch the one or more types of workloads and accordingly modifies the GPU AI cloud infrastructure 210 upon receiving the one or more policy specifications from the one or more users 102.

The architecture 200 may further include one or more users 102 such as the first user 102a and the second user 102b, who may give one or more inputs to the orchestrator 202. In one embodiment, the one or more inputs may include correlation rules and policy rules.

In an embodiment, the orchestrator 202 may be a central management engine that may be configured to automate the coordination and allocation of resources between the AI cloud infrastructure 210 and the one or more types of workloads 208. The orchestrator 202 may ensure that the workloads are efficiently scheduled, configured, and switched according to predefined policies without manual intervention.

In an embodiment, the correlation engine 204 may be configured to collect one or more events from both the AI cloud infrastructure 210 and one or more types of workloads 208. The one or more events may include one or more of a data on resource usage, performance metrics, failures, etc. The correlation engine 204 may be further configured to analyze one or more events to identify correlations.

For example, multiple failure events might be traced back to a single link failure in the network. The result is a “correlated event,” which is a more meaningful and actionable piece of information that the orchestrator 202 may use.

In an embodiment, the policy engine 206 may be configured to receive one or more policy specifications from the one or more users 102. The one or more policy specifications may indicate the set of user-defined rules and configurations to manage the one or more types of workloads 208 to run on one or more GPU resources.

Further, when the correlated events are passed from the correlation engine 204, the policy engine 204 may be configured to check them against the pre-configured policies. In a case, if the trigger condition is met, the policy engine 204 initiates the corresponding actions. The corresponding actions may include a workload switch, resource reallocation, or memory adjustments.

In one embodiment, when the policy engine 204 may determine that an action is required, and the action involves a predefined sequence of steps, the policy engine 204 may invoke the workflow-based action 216 component. The workflow in this context may be a set of predetermined steps that may be executed automatically without the need for further analysis or decision-making. An example may include assigning internet protocol (IP) addresses or initializing specific hardware components.

In another embodiment, in cases where the action is more complex and requires understanding of high-level objectives (intent), such as optimizing for cost, location, or specific resource requirements, the intent-based action 218 component may be invoked. The intent based action 218 component may be configured to break down high-level intent into specific requirements and tasks. The intent-based action 218 may involve resolving dependencies between the one or more types of workloads 208 and the GPU AI cloud infrastructure 210, ensuring the correct resources are provisioned before switching the workloads.

The system 108 may be configured to operate in a closed-loop manner, where events from the GPU AI cloud infrastructure 210 and the one or more types of workloads 208 continuously notify the orchestrator 102, which then applies policies to make decisions and execute actions.

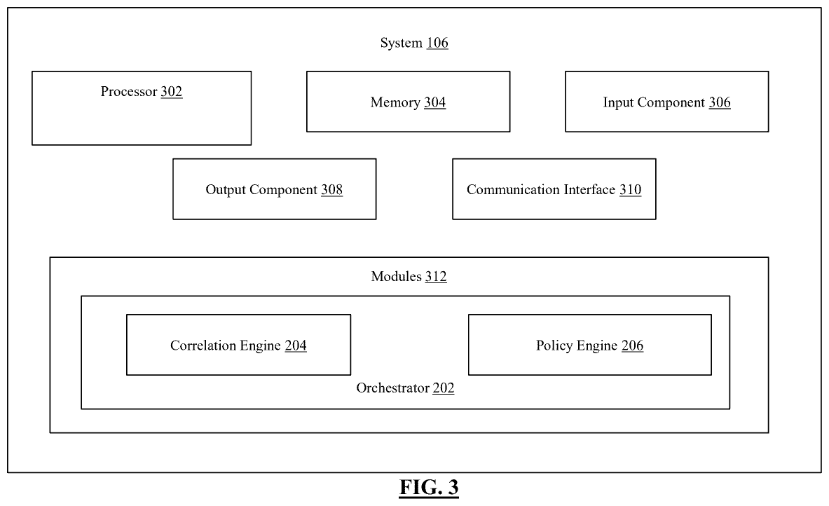

In various embodiments, the system 108 for dynamically managing graphics processing unit (GPU) workloads in artificial intelligence (AI) cloud infrastructure may be discussed in detail in conjunction with FIG. 3.

FIG. 3 illustrates the schematic diagram depicting the system 108 for dynamically managing the GPU workloads in the GPU AI cloud infrastructure 210, according to an embodiment of the present disclosure.

In an embodiment of the present disclosure, the system 108 may be deployed at the remote server 106.

The system 108 may include but is not limited to, one or more processors 302 (referred to as the “processor 302”), a memory 304, an input component 306, an output component 308, a communication interface 310, and one or more modules 312.

The one or more processors 302 may be a single processing unit or several units, all of which could include multiple computing units. The one or more processors 302 may be implemented as one or more microprocessors, microcomputers, microcontrollers, digital signal processors, central processing units, state machines, logic circuitries, and/or any devices that manipulate signals based on operational instructions. Among other capabilities, the one or more processors 302 are adapted to fetch and execute computer-readable instructions and data stored in the memory 304.

In one embodiment, the memory 304 may include suitable logic, circuitry, and interfaces that may be configured to store data associated with the system 108 for dynamically managing the GPU workloads in the GPU AI cloud infrastructure 210, machine learning modules, and other data. Examples of the memory 304 may include, but are not limited to, a random-access memory (RAM), a read-only memory (ROM), a removable storage drive, a hard disk drive (HDD), a flash memory, a solid-state memory, or the like. It will be apparent to a person skilled in the art that the scope of the disclosure is not limited to realizing the memory 304 in the system 108, as described herein. In other embodiments, the memory 304 may be realized in the form of a database or a cloud storage working in conjunction with the processor 302, without deviating from the scope of the disclosure.

The input component 306 may be configured to receive information, such as user input. For example, the input component 306 may include, but not be limited to, a touchscreen display, a keyboard, a keypad, a mouse, a button, a switch, and/or a microphone associated with the system 108.

The output component 308 may be configured to display information from the system 108 to the one or more users 102 or other systems, utilizing a variety of devices and technologies tailored to specific application needs. The output component 308 may include visual output devices such as display screens, Liquid Crystal Displays, Light Emitting Diodes, Organic Light Emitting Diode (LCD, LED, OLED), projectors, and heads-up displays (HUDs) for presenting graphical or textual information. Additionally, auditory output through speakers and headphones provides audio feedback and alerts, while haptic output devices, like vibration motors in smartphones or game controllers, offer tactile feedback. Functionally, the output component 308 serves multiple roles, including displaying graphical user interface (GUI) elements for user interaction, delivering notifications and alerts through sound, visual indicators, or vibrations, and rendering complex data visualizations like charts and graphs for easier comprehension.

In an embodiment, the output component 308 may be configured to receive processed data from the processor 302, which determines the information to be communicated, and the output component 308 may access the memory 304 to retrieve and display stored information such as documents, media files, or application states.

Furthermore, the output component 308 may be configured to meet the specific requirements of different applications, such as high-resolution visual output and immersive audio for gaming systems or clear and precise data visualization and alert mechanisms for industrial control systems. Through these varied output methods, the output component 308 ensures effective communication of information, enhancing both system 108 functionality and user experience.

The communication interface 310 is a hardware and/or software component that may be configured to enable the system 108 to exchange data with other user devices or systems. The communication interface 310 may be configured to serve as the link for transmitting and receiving information, either within a local environment (e.g., between components of the same system) or across networks.

The one or more modules 312, amongst other things, include routines, programs, objects, components, data structures, etc., which perform particular tasks or implement data types. The module(s) 312 may also be implemented as, signal processor(s), state machine(s), logic circuitries, and/or any other device or component that manipulates signals based on operational instructions.

Further, the one or more modules 312 may be implemented in hardware, instructions executed by a processing unit, or by a combination thereof. The processing unit can comprise a computer, a processor, such as the one or more processors 302, a state machine, a logic array, or any other suitable devices capable of processing instructions. The processing unit can be a general-purpose processor which executes instructions to cause the general-purpose processor to perform the required tasks or, the processing unit can be dedicated to performing the required functions. In another embodiment of the present disclosure, the one or more modules 312 may be machine-readable instructions (software) which, when executed by the processor/processing unit 302, perform any of the described functionalities.

In an embodiment, the one or more modules 312 may include the orchestrator 202. The orchestrator 202 may further include the correlation engine 204 and the policy engine 206.

The correlation engine 204 may be configured to collect the one or more events from both the GPU AI cloud infrastructure 210 and the one or more types of workloads 208. The one or more events may include the one or more of data on resource usage, performance metrics, failures, etc. The correlation engine 204 may be further configured to analyze the one or more events to identify correlations or root causes.

The policy engine 206 may be configured to receive the one or more policy specifications from the one or more users 102. The one or more policy specifications indicate a set of user-defined rules and configurations to manage the one or more types of workloads 208 to run on the one or more GPU resources.

Further, when the correlated events are passed from the correlation engine 204, the policy engine 204 may be configured to check correlated events against the pre-configured policies. If the trigger condition is met, the policy engine 204 may be configured to initiate the corresponding actions. The corresponding actions may include the workload switch, the resource reallocation, or the memory adjustments.

In one embodiment, when the policy engine 206 determines that an action is required, and the action involves a predefined sequence of steps, the policy engine 204 may invoke the workflow-based action 216 component. The workflow in this context is a set of predetermined steps that execute automatically without the need of further analysis or decision-making.

In operation, the processor 302 may be configured to monitor the GPU AI cloud infrastructure 210, comprising the one or more types of workloads 208. The one or more types of workloads 208 may include distinct computational use cases, such as model training, real-time inference, or batch processing. The one or more types of workloads 208 may indicate different use cases that require computational tasks that are executed on the AI cloud infrastructure 210.

The processor 302 may be configured to receive the one or more policy specifications from the one or more users 102. The one or more policy specifications indicate the set of user-defined rules and configurations to manage the one or more types of workloads 208 to run on the one or more GPU resources. In one embodiment, the one or more policy specifications may include one or more pre-defined parameters related to the one or more types of workloads 208.

The processor 302 may be further configured to switch the one or more types of workloads 208 based on the received one or more policy specifications. The switching operation may include terminating workloads, pausing workloads, or migrating existing workloads to facilitate the execution of higher-priority or more resource-efficient workloads.

The processor 302 may be further configured to modify the GPU AI cloud infrastructure 210 based on the switching of the one or more types of workloads 208, thereby dynamically managing the GPU workloads in the GPU AI cloud infrastructure 210. The modifications may include reconfiguring containerized deployment environments, adjusting virtual machine templates, or provisioning additional GPU instances as needed to meet the one or more policy specifications.

In another embodiment, the processor 302 may be configured to track performance metrics of the one or more types of workloads 208 in real-time. The performance metrics may include a GPU utilization rate, memory consumption, task latency, throughput, or energy usage, which provide dynamic feedback for enforcing policy-driven decisions.

The performance metrics monitored by the processor 302 serve as dynamic feedback inputs that enable enforcement of the policy-driven decisions in real-time. The performance metrics may allow for adaptive workload management and infrastructure modification within the GPU AI cloud infrastructure 210.

In an embodiment, the GPU utilization rate may refer to the percentage of time the GPU is actively processing instructions, indicating effectiveness of the GPU.

For example, if a policy specification sets a threshold of 85% utilization, the processor 302 may trigger a resource reallocation or workload redistribution when utilization drops below the threshold of 85% to ensure an optimal usage.

In an embodiment, the memory consumption may denote the amount of GPU memory being used by a workload. In an embodiment, monitoring the memory consumption metric ensures workloads do not exceed memory limits or cause resource contention.

For example, if a workload exceeds 90% memory usage, the processor 302 may automatically scale out additional GPU instances to prevent memory overflow.

The task latency may refer to the time delay between submitting the one or more types of workloads 208 and receiving the corresponding output. It is critical for time-sensitive or interactive AI workloads. In an example, for a policy requiring response times under 100 milliseconds, the processor 302 may switch to lower-latency GPU models if latency exceeds the threshold.

The throughput may refer to the number of computational tasks or data samples processed per unit of time by the one or more GPU resources.

For example, when a policy targets a minimum of 10,000 inferences per second for a real-time inference engine, the processor 302 may provision additional GPUs if throughput drops below a specified limit of 10,000 inferences per second.

In an embodiment, the energy usage may measure the power consumption of the one or more GPU resources while executing workloads. The energy usage metric is useful for optimizing operational costs and adhering to sustainability policies. For example, if the energy consumption exceeds a set budgetary threshold, the orchestrator (202) may reallocate the workloads to energy-efficient GPU nodes to reduce power usage while maintaining performance.

In another embodiment, the processor 302 may be configured to reallocate the one or more GPU resources between the one or more types of workloads 208 based on the policy specified by the one or more users 102. The reallocation may involve detaching the GPUs from one workload context and reattaching them to another, guided by system-level orchestration rules to ensure minimal disruption.

For example, consider a scenario where the first user 102a defines a policy specification indicating that during business hours (9:00 AM to 6:00 PM), the one or more GPU resources should prioritize low-latency inference workloads to support user-facing applications, while during off-peak hours, the infrastructure should switch to computationally intensive model training workloads.

The processor 302, upon receiving the policy specification, may be configured to continuously monitor the real-time clock and performance metrics of the currently running workloads. At 6:01 PM, the processor 302 may be configured to evaluate the policy condition, confirms that the policy trigger time is met, and identify that training workloads need to be scheduled.

Consequently, the processor 302 may initiate a workload switch by transitioning inference services to a low-resource standby mode and begin executing queued training tasks. The switch involves terminating idle inference pods, allocating GPUs to training containers, and adjusting memory reservations. To support this change, the processor 302 may be configured to modify the GPU AI cloud infrastructure 210 by reconfiguring container environments and launching new training pipelines. Concurrently, the processor 302 may continue to track performance metrics such as training throughput and GPU temperature to validate that the infrastructure is performing within acceptable thresholds.

The processor 302 may be configured to detect the anomaly via performance metrics and reallocate a portion of the one or more GPU resources from training workloads to inference workloads if an unexpected spike in inference demand occurs during off-peak hours.

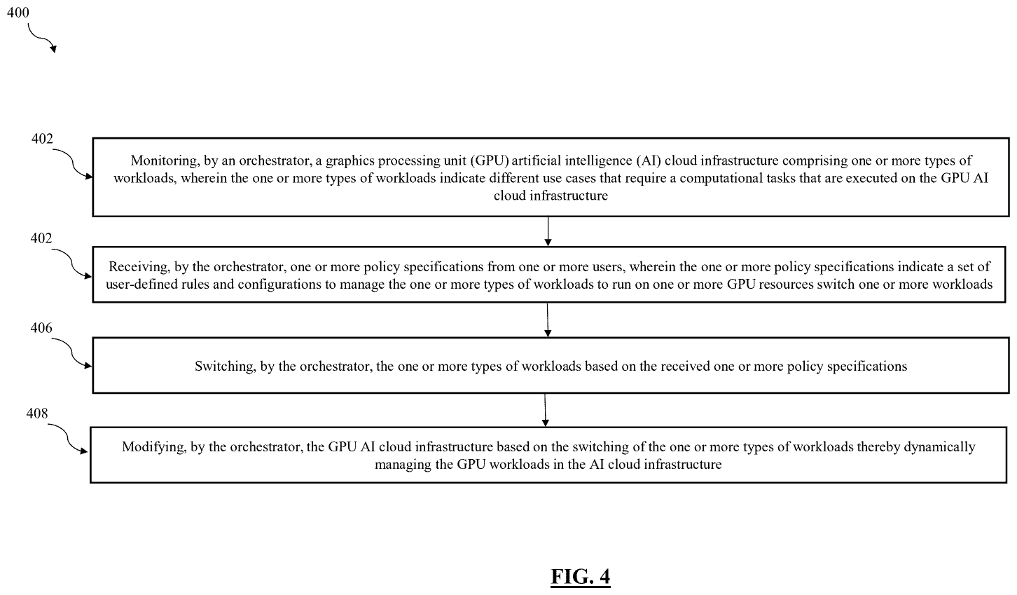

FIG. 4 illustrates a flowchart depicting the method 400 for dynamically managing the GPU workloads in the GPU AI cloud infrastructure 210, according to an embodiment of the present disclosure.

At step 402, the method 400 includes monitoring, by the orchestrator 202, the GPU AI cloud infrastructure 210 including the one or more types of workloads 208. The one or more types of workloads 208 may indicate different use cases that require the computational tasks that are executed on the GPU AI cloud infrastructure 210.

At step 404, the method 400 may include receiving, by the orchestrator 202, the one or more policy specifications from the one or more users 102. The one or more policy specifications may indicate the set of user-defined rules and configurations to manage the one or more types of workloads 208 to run on the one or more GPU resources.

At step 406, the method 400 may include switching, by the orchestrator 202, the one or more types of workloads 208 based on the received one or more policy specifications.

At step 408, the method 400 may include modifying, by the orchestrator 202, the GPU AI cloud infrastructure 210 based on the switching of the one or more types of workloads 208, thereby dynamically managing the GPU workloads in the GPU AI cloud infrastructure 210.

Now, the advantages of the present disclosure is discussed in the forthcoming paragraphs. The present disclosure enables dynamic management of the GPU workloads in the GPU AI cloud infrastructure 210 through policy-driven orchestration. The orchestrator 202 interprets user-defined policy specifications to automate the workload switching and infrastructure modification. This approach eliminates the need for manual workload scheduling, allowing for efficient and autonomous execution of diverse workload types 208 based on contextual priorities defined by the one or more users 102.

Another advantage of the present disclosure facilitates intelligent allocation and reallocation of the one or more GPU resources in response to real-time performance metrics and user-defined rules. The processor 302 may be configured to dynamically optimize resource distribution across concurrent workloads 208 by continuously tracking operational parameters such as GPU utilization, latency, and throughput, thereby maximizing infrastructure efficiency and ensuring compliance with service-level expectations.

A further advantage of the present disclosure provides both workflow-based and intent-based actions for executing policy-driven decisions. The workflow-based action 216 component enables deterministic execution of predefined operational procedures, while the intent-based action 218 component interprets high-level user intents into executable resource provisioning tasks. This dual-mode action framework allows the system 108 to address both routine operational requirements and complex optimization goals, thereby enhancing system adaptability.

Yet another advantage of the present disclosure is that it provides a unified mechanism for modifying the underlying GPU AI cloud infrastructure 210 in response to workload transitions. Infrastructure modifications, including GPU instance provisioning, memory configuration, and service redeployment are automatically triggered based on workload switching decisions, ensuring that resource environments remain aligned with the operational needs of each workload type 208 without manual intervention.

Furthermore, embodiments of the disclosed methods, processes, modules, devices, systems, and computer program products may be readily implemented, fully or partially, in software using, for example, object or object-oriented software development environments that provide portable source code that can be used on a variety of computer platforms. Alternatively, embodiments of the disclosed methods, processes, modules, devices, systems, and computer program products can be implemented partially or fully in hardware using, for example, standard logic circuits or a very-large-scale integration (VLSI) design. Other hardware or software can be used to implement embodiments depending on the speed and/or efficiency requirements of the systems, the particular function, and/or particular software or hardware system, microprocessor, or microcomputer being utilized.

In this application, unless specifically stated otherwise, the use of the singular includes the plural and the use of “or” means “and/or.” Furthermore, use of the terms “including” or “having” is not limiting. Any range described herein will be understood to include the endpoints and all values between the endpoints. Features of the disclosed embodiments may be combined, rearranged, omitted, etc., within the scope of the present disclosure to produce additional embodiments. Furthermore, certain features may sometimes be used to advantage without a corresponding use of other features.

I/We claim:

1. A method (400) for dynamically switching graphics processing unit (GPU) workloads in GPU artificial intelligence (AI) cloud infrastructure (210), the method (400) comprising:
monitoring, by an orchestrator (202), the GPU AI cloud infrastructure (210) comprising one or more types of workloads (208), wherein the one or more types of workloads (208) indicate different use cases that require a computational tasks that are executed on the GPU AI cloud infrastructure (210);
receiving, by the orchestrator (202), one or more policy specifications from a one or more users (102), wherein the one or more policy specifications indicate a set of user-defined rules and configurations to manage the one or more types of workloads (208) to run on one or more GPU resources;
switching, by the orchestrator (202), the one or more types of workloads based on the received one or more policy specifications; and
modifying, by the orchestrator (202), the GPU AI cloud infrastructure (210) based on the switching of the one or more types of workloads (208), thereby dynamically managing the GPU workloads in the GPU AI cloud infrastructure (210).

2. The method (400) as claimed in claim 1, wherein the monitoring the GPU AI cloud infrastructure (210), comprises:
tracking performance metrics of the one or more types of workloads (208) in real-time.

3. The method (400) as claimed in claim 1, comprising:
reallocating one or more GPU resources between the one or more types of workloads (208) based on the policy specified by the one or more users (102).

4. The method (400) as claimed in claim 1, wherein the one or more policy specifications include one or more pre-defined parameters related to the one or more types of workloads (208).

5. A system (108) for dynamically switching graphics processing unit (GPU) workloads in a GPU AI cloud infrastructure (210), the system (108) comprising:
a memory (304);
an orchestrator (202); and
at least one processor (302) in communication with the memory (304) and the orchestrator (202) is configured to:
monitor the GPU AI cloud infrastructure (210) comprising one or more types of workloads (208), wherein the one or more types of workloads (208) indicate different use cases that require computational tasks that are executed on the GPU AI cloud infrastructure (210);
receive one or more policy specifications from a one or more users (102), wherein the one or more policy specifications indicate a set of user-defined rules and configurations to manage the one or more types of workloads (208) to run on one or more GPU resources;
switch the one or more types of workloads (208) based on the received one or more policy specifications; and
modify the GPU AI cloud infrastructure (210) based on the switching of the one or more types of workloads (208), thereby dynamically managing the GPU workloads in the GPU AI cloud infrastructure (210).

6. The system (108) as claimed in claim 5, wherein the monitoring the GPU AI cloud infrastructure (210), the at least one processor (302) is configured to:
track performance metrics of the one or more types of workloads (208) in real-time.

7. The system (108) as claimed in claim 5, wherein the at least one processor (302) is configured to:
reallocate one or more GPU resources between the one or more types of workloads (208) based on the one or more policy specifications received from the one or more users (102).

8. The system (108) as claimed in claim 5, wherein the one or more policy specifications include one or more pre-defined parameters related to the one or more types of workloads (208).
